(19) United States
(12) Patent Application Publication
(10) Pub. No.: US 2018/0355956 A1
(43) Pub. Date: Dec. 13, 2018

(54) Compartmentalized Riding Trowel Cvt Clutch Module

(71) Applicant: Allen Engineering Corporation, Paragould, AR (US)

(72) Inventor: Jeffrey Lynn Fielder, Jonesboro, AR (US)

(73) Assignee: Allen Engineering Corporation, Paragould, AR (US)

(21) Appl. No.: 15/982,025

(22) Filed: May 17, 2018

Related U.S. Application Data
(60) Provisional application No. 62/516,507, filed on Jun. 7, 2017.

(51) Int. Cl. F16H 9/12; E04F 21/24

(52) U.S. Cl. CPC F16H 9/125; F16H 2007/0865; E04F 21/248

(57) ABSTRACT

A modular, continuously variable ratio transmission adapted to be coupled between the drive motor of a dual rotor riding trowel and the lower drive train. First and second rigid, generally planar frame plates are secured in parallel relation by a plurality of spacers. The first fame plate has a clearance orifice for admitting a portion of the trowel engine. A stub shaft receives input power and rotates a first pulley that drives a second pulley with a reduced diameter. A first jackshaft driven by said second pulley drives a variable CVT drive pulley affixed externally of the module. A second variable drive pulley coupled to said first variable drive pulley by a belt drives a second jackshaft splined to a fifth pulley that is coupled to a sixth pulley having a diameter greater than the diameter of said fifth pulley. The sixth pulley is coupled to trowel gearbox drive shafts.

### CROSS REFERENCE TO RELATED APPLICATION

This utility conversion patent application is based upon, and claims priority from, prior U.S. Provisional Patent Application Ser. No. 62/516,507, filed Jun. 7, 2017, and entitled “Compartmentalized Riding Trowel Cvt Clutch Module” by inventor Jeffrey Lynn Fielder.

### BACKGROUND OF THE INVENTION

### I. Field of the Invention

The present invention relates generally to continuously variable transmissions (i.e., “CVT”) adapted for motorized riding trowels for finishing concrete. More particularly, the present invention relates to motor powered riding trowels of the type classified in United States Patent Class 404, Subclass 112, and to CVT transmission systems for such trowels.

### II. Description of the Prior Art

As recognized in the art, freshly placed concrete must be appropriately finished to insure optimum surface characteristics, including appropriate smoothness and flatness. Motorized riding trowels are ideal for finishing very large areas of plastic concrete quickly and efficiently, and such trowels have become a standard in the industry. A typical power riding trowel comprises two bladed rotor assemblies that frictionally contact the surface for finishing, which can be tilted for steering as is known in the art.

As freshly poured concrete “sets,” it soon becomes hard enough to support the weight of the specialized finishing trowel, so pan finishing can begin. By starting panning while concrete is still “green,” within one to several hours after pouring depending upon the concrete mixture involved, “super-flat” and “super-smooth” floors can be achieved. The advent of more stringent concrete surface finish specifications using “F” numbers to specify flatness (ff) and levelness (fl), dictates the use of pans on a widespread basis.

The panning process comprises three different recognizable stages. In the initial “brake open” stage, the rotors are ideally driven between 40 and 65 RPM. As the concrete hardens, the pan floating stage occurs, involving rotor speeds between 70 and 95 RPM. The last phase of pan floating, the “fuzz stage,” uses an increased rotor speed of between 95-125 RPM. At present these RPM requirements are achieved simply by varying motor speed.

Pan finishing is normally followed by medium speed blade finishing, after the pans are removed from the rotors. An enhancement is the use of “combo blades” during the intermediate “fuzz stage” as the concrete continues to harden. So-called “combo-blades” are a compromise between pans and normal finishing blades. They present more surface area to the concrete than normal finishing blades, and attack at a less acute angle. The rotors are preferably turned between 100 to 135 RPM at this time. Finishing blades are then used, and they are rotated between 120 to 150 RPM. Finally, the pitch of the blades is changed to a relatively high contact angle, and burnishing begins. This final trowel finishing stage uses rotor speeds of between 135 and 185 RPM.

Modern large, high power riding trowels can deliver substantial horsepower. During use, however, the drive train, the gearboxes, the rotors and the motors are subject to substantial stresses. Motor loading varies as the rotor RPM requirements change. Furthermore, ideal rotation speeds can vary depending upon the concrete, whose frictional characteristics vary between the freshly poured and stricken off stage, the subsequent green stages, and final curing and hardening. The motors function most efficiently at a given operating point in their characteristic horsepower-RPM and torque-RPM curves. Especially with diesel engines, optimum torque and horsepower requirements are achieved over a limited RPM range.

The engines on most riding trowels directly power the reduction drive gear boxes connected to the rotor shafts. The incoming shaft speed of the conventional rotor gear box is the same as the motor output RPM. The gearbox output shaft speed (i.e., rotor speed) is reduced, approximately 20:1. Engine RPM is usually the key variable related to output power. However, with engine speed increases, excessive power may be developed and the finishing mechanism may rotate too fast. For example, the initial panning stage requires relatively high power because of the viscous character of the still-wet concrete, but relatively low rotor speeds are desired. Since the rotors are driven through a fixed ratio, established by the gearbox and pulleys, optimum engine power often cannot be obtained during panning without risking excessive rotor speeds.

It has thus proven desirable to provide a CVT riding trowel wherein the engine and gear boxes can operate at ideal speeds over a wide range of finishing conditions.

Prior U.S. Pat. No. 5,108,220 owned by Allen Engineering Corporation, the same assignee as in this case, relates to an improved, fast steering system for riding trowels. Its steering system enhances riding trowel maneuverability and control. The latter fast steering riding trowel is also the subject of U.S. Pat. No. Des. 323,510 owned by Allen Engineering Corporation.

Allen Engineering Corporation U.S. Pat. No. 5,613,801 issued Mar. 25, 1997 discloses a power riding trowel equipped with twin motors. The latter design employs a separate motor to power each rotor. Steering is accomplished with structure similar to that depicted in U.S. Pat. No. 5,108,220 previously discussed.

Allen U.S. Pat. No. 5,480,257 depicts a twin engine powered riding trowel whose guard structure is equipped with an obstruction clearance system. When troweling areas characterized by projecting hazards such as pipes or ducts, or when it is necessary to trowel hard-to-reach areas adjacent walls or the like, the guard clearance structure may be retracted to apply the blades closer to the target region.

Allen U.S. Pat. No. 5,685,667 depicts a twin engine riding trowel using “contra rotation.” For enhanced stability and steering, the rotors rotate in a direction opposite from that normally expected in the art.

U.S. Pat. No. 5,967,696 Oct. 19, 1999 issued to Allen Engineering Corporation depicts a CVT riding trowel, i.e., a trowel with a variable ratio transmission. The trowel described in the latter patent includes a CVT drive train powering a pair of rotors. The rotors are shaft driven by reduction gear boxes. The CVT system comprises a variable ratio pulley driven by the internal combustion motor, which can be diesel powered, gasoline powered or propane powered. A second variable ratio pulley drives the gear box input shaft, with a drive belt entrained between the twin, variable ratio pulleys. Means are provided to change the effective diameters of the belt-coupled pulleys. The varying ratio between the pulleys establishes a variable, overall drive gear ratio.

Allen Engineering Corporation U.S. Pat. No. 9,068,300 addresses efficiency issues vis-a-vis power train efficiency. Prior to said patent, for examples, pulleys in a conventional CVT trowel system would operate at the drive motor output shaft speed or RPM. Variable gear reduction offered to the gearbox drive shaft then reduces applied RPM from that of the motor. U.S. Pat. No. 9,068,300 addresses the discovery that a CVT system that first highly increases the RPM from that of the drive motor can thereafter more efficiently deliver the required lower speed and torque to the gearbox through the CVT arrangement.

### SUMMARY OF THE INVENTION

This invention provides a continuously variable ratio transmission (i.e., “CVT”) module configured in a rugged, compact and efficient compartmentalized form that makes it relatively easy to install in conventional riding trowels. The compartmentalized module mechanically couples between the drive motor or motors and the lower drive train.

A typical riding trowel comprises one or more engines for powering downwardly projecting rotors whose blades frictionally contact the concrete surface. The rotors are driven by reduction gear boxes that are shaft activated. By tilting the rotors, steering forces are developed. The CVT module is mechanically interposed adjacent the engine, with twin gearbox input shafts projecting towards the rotors.

The new modular CVT configuration facilitates higher power applications by reducing the torque and subsequently the belt tension in the CVT. Belt tension is directly related to the torque on the rotating pulleys. Power is the product of torque and speed. Therefore, increasing the speed of the CVT pulleys will result in lower torque. The CVT module input section steps up the applied motor speed, rather than stepping it down. With the enhanced CVT first stage input speed, and resultant torque and RPM characteristics, overall efficiency is achieved. Subsequent CVT pulley sections reduce speed sufficiently to drive the gearbox shafts at a desired speed.

A basic object of this invention is to provide a CVT power module for use with concrete finishing machines, notably power riding trowels.

It is also a broad object to provide a CVT module of the character described in U.S. Pat. No. 9,068,300 that is separate from both the trowel motor and the trowel frame.

Another basic object is to improve the bearing construction of a CVT module of the type seen in U.S. Pat. No. 9,068,300.

Similarly it is an object to provide an improved belt tensioning system for CVT modules of the character described.

It is also a fundamental object to provide a “quick-change” CVT module for riding trowels.

Another underlying object of this invention is to increase the efficiency of a riding trowel, or other motor-powered device, by employing a CVT transmission.

A related object is to optimize trowel efficiency and CVT efficiency by allowing the CVT transmission to operate at speeds higher than the motor output shaft speed, and to gear down the output speed to match the required rotor gearbox speed.

Another object is to provide a compact, modular CVT system ideal for riding trowels that enables the rotors to operate at a variety of speeds while allowing the drive motor or motors to operate at optimum speeds.

A related object is to provide a CVT module for power finishing trowels or similar motor-powered equipment.

Another important object is to provide a CVT system whereby motor speeds can be varied during concrete finishing operations, while rotor speeds are substantially maintained.

Conversely, an important object is to enable rotor speed to be varied substantially as desired during different finishing stages, while maintaining substantially constant motor speed and motor torque.

A basic object, that is intertwined with all of the above, is to increase the overall efficiency of the power outputted by a trowel by allowing the CVT to run at higher-than-normal speeds (i.e., 6000 RPM) while maintaining proper rotor and gearbox speeds.

Another basic object of my invention is to provide an optimum overall gear ratio at all times during the concrete finishing process.

A related object is to provide a CVT module for riding trowels that is ideal either during panning or blading.

A still further object of my invention is to provide a CVT module for riding trowels that increases production and efficiency.

These and other objects and advantages of the present invention, along with features of novelty appurtenant thereto, will appear or become apparent in the course of the following descriptive sections.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is left, frontal isometric view showing the preferred CVT module adapted to be mounted to an internal combustion engine of the type suitable for use with modern dual-rotor riding trowels;

FIG. 2 is a right frontal isometric view of my new CVT module;

FIG. 3 is a rear isometric view of my new CVT module;

FIG. 4 is a rear isometric view of the preferred CVT system; and,

FIG. 5 is an enlarged, fragmentary, right elevational view.

### DETAILED DESCRIPTION OF THE PREFERRED EMBODIMENT

The subject matter of this patent is related to one or more of the following U.S. Pat. No. D323,510 issued January 1992; U.S. Pat. No. 3,936,212 issued February 1976; U.S. Pat. No. 4,046,484 issued Sep. 6, 1977; U.S. Pat. No. 4,312,603 issued Jan. 26, 1982; U.S. Pat. No. 4,556,339 issued Dec. 3, 1985; U.S. Pat. No. 4,676,691 issued Jun. 10, 1987; U.S. Pat. No. 4,710,055 issued Dec. 1, 1987, U.S. Pat. No. 5,108,220 issued Apr. 28, 1992; U.S. Pat. No. 5,238,323 issued Aug. 24, 1993; U.S. Pat. No. 5,405,216 issued Apr. 11, 1995; U.S. Pat. No. 5,480,257 issued Jan. 2, 1996; U.S. Pat. No. 5,480,258 issued Jan. 2, 1996; U.S. Pat. No. 5,613,801 issued Mar. 25, 1997; U.S. Pat. No. 5,658,089 issued Aug. 19, 1997; U.S. Pat. No. 5,685,667 issued Nov. 11, 1997; U.S. Pat. No. 5,803,658 issued Sep. 8, 1998; U.S. Pat. No. 5,934,823 issued Aug. 10, 1999; U.S. Pat. No. 5,988,938 issued Nov. 23, 1999; U.S. Pat. No. 6,019,545 issued Feb. 1, 2000; and U.S. Pat. No. 9,068,300 issued Jun. 30, 2015. For purposes of disclosure, and compliance with enablement and disclosure requirements of 35 USC Sec. 112 et. seq., the foregoing patents are hereby incorporated by reference as if fully set forth herein.

The subject matter of this patent is also related to one or more of the following other references: “Hi-Lo Variable Speed Pulley Drives” brochure by Hi-Lo Manufacturing Co., November 1994; “TS 78 Multi-Lap Ride-On Power Trowel” Spec Sheet by Bartell Powell Products; Bartell “Power Trowels” Brochure “Speed Selector Inc.'s “Variable Speed Drives & Accessories” Brochure form 910-1-9; For purposes of disclosure, and compliance with 35 USC Sec. 112, the foregoing references are hereby incorporated by reference as if fully set forth herein.

With reference to the accompanying drawings, a CVT module constructed according to the best mode of the invention has been designated generally by the reference numeral 20. CVT module 20 is adapted to be employed upon a dual rotor riding trowel of the type known in the art, which has been described in a plurality of the previously discussed references. It should be appreciated that the applicable trowel may comprise either modern hydraulic steering, or it may employ older, manual steering arrangements. The drive engine may be diesel, gasoline, or gas (i.e., propane) powered.

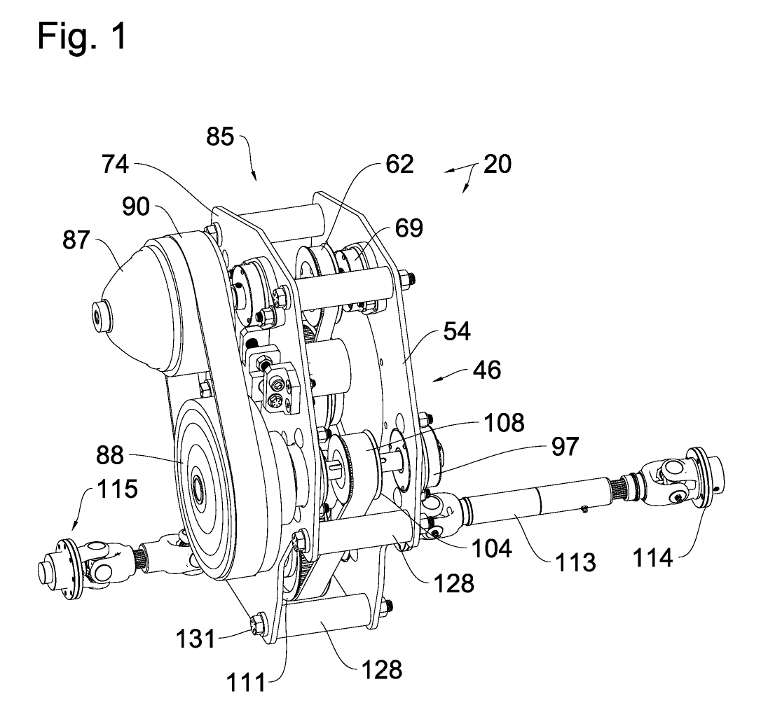

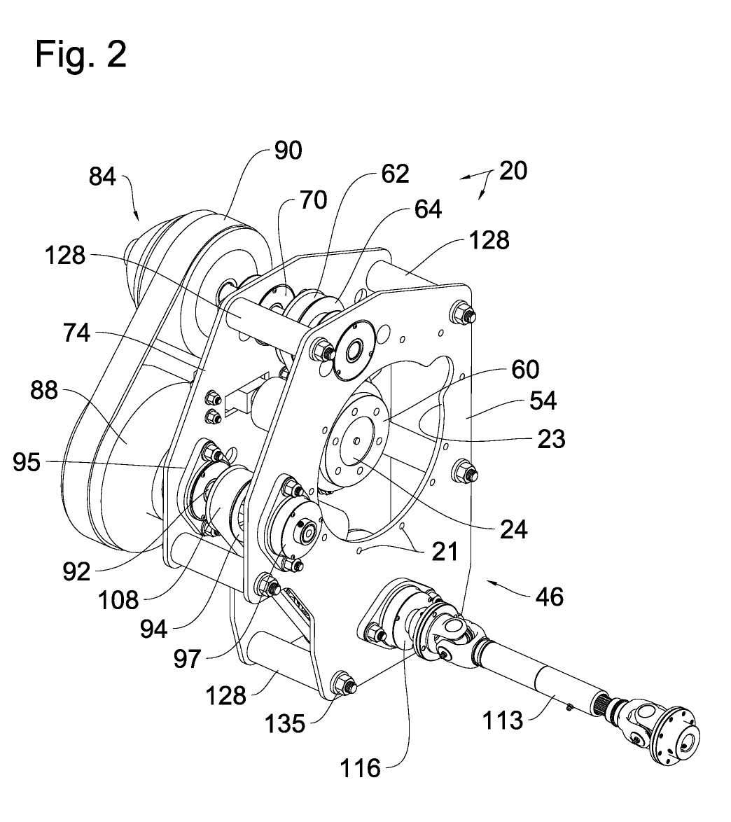

The CVT module 20 is preferably mounted upon suitable rigid support structure adjacent the drive engine of a trowel or other motor-propelled implement proximate the main frame. The power input end of the CVT module has been generally designated by the reference numeral 46 in FIGS. 1, and 2. The CVT module is positioned proximate the output end of a conventional internal combustion engine, with the engine flywheel (not shown) clearing orifice 23 (FIG. 2) that is defined in module frame plate 54. The internal combustion drive engine couples to stub shaft 24 to transmit power into the CVT unit 20. The module 20 is secured to the engine of the trowel with suitable fasteners penetrating mounting orifices 21 defined in plate 54 that bolt to the internal combustion engine backing plate.

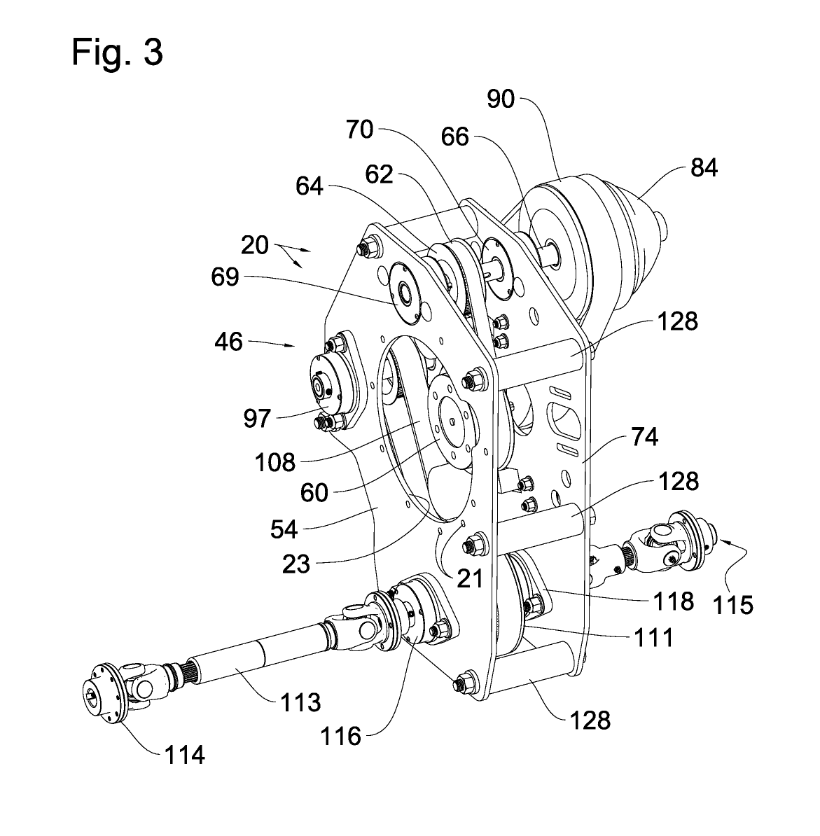

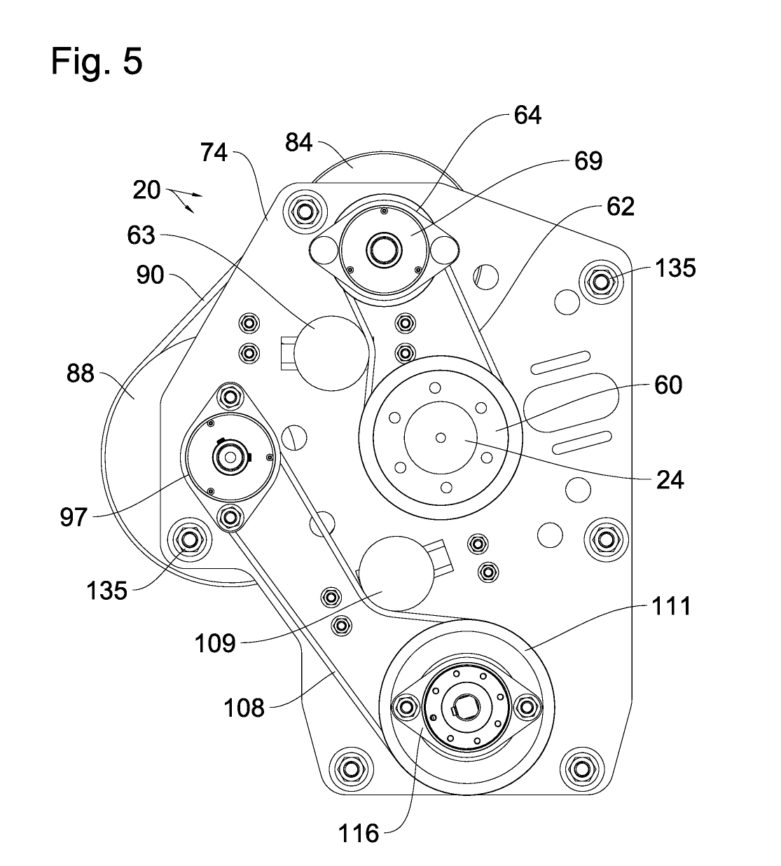

Power is inputted through the input stage of the CVT unit (i.e., the first stage) via a pulley 60 (i.e., FIGS. 2, 3) that is splined to PTO stub shaft 24. Belt 62 entrained over pulley 60 is coupled to a reduced diameter pulley 64 that is positioned above pulley 60, and journalled for rotation between frame plates 54 and 74 (i.e., FIG. 3). Preferably an idler pulley 63 (i.e., FIG. 5) maintains proper tension against belt 62. Pulley 64 thus rotates faster than pulley 60, as it has a reduced diameter. Pulley 64 is splined to a jackshaft 66 (FIG. 3) that penetrates it and terminates through a suitable bushing within a roller bearing 69 attached to frame plate 54. Jackshaft 66, which extends between frame plates 54 and 74, rotates at a higher speed and lower torque than the engine flywheel that is coupled to stub shaft 24 as described above.

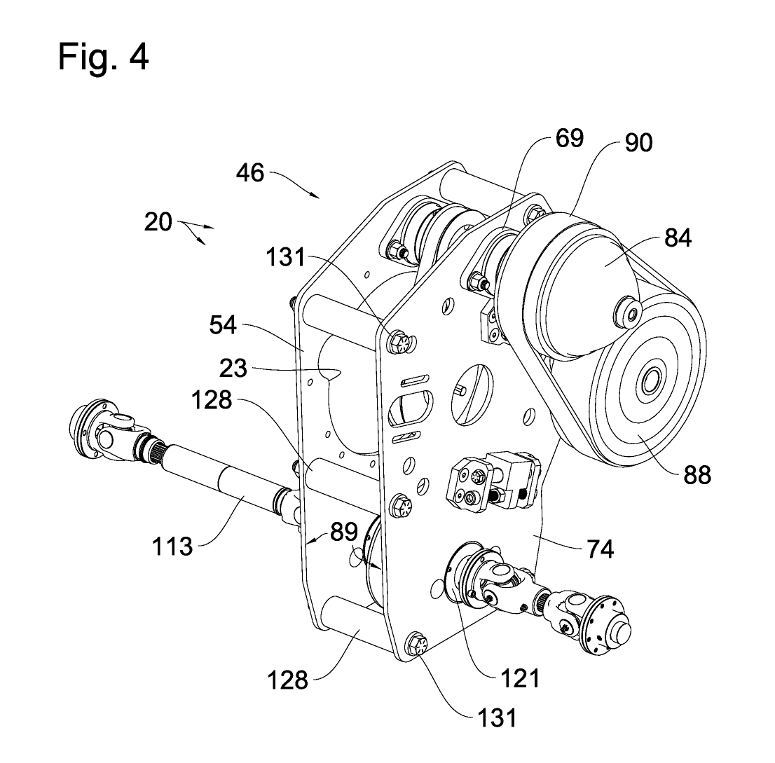

Jackshaft 66 is escapes through frame plate 74 through a bearing 70 affixed to a frame plate 74 that is parallel with and spaced apart from frame plate 54 described previously. Jackshaft 66 penetrates frame plate 74 and terminates within and is splined to a variable drive pulley 84 affixed externally of the CVT module. Pulley 84 can change its effective diameter, varying the speed and torque transmitted to lower, variable pulley 88 (FIG. 4) by belt 90. Pulley 84 will be driven by jackshaft 66 at a higher speed than the engine, therefore operating at a lower torque. CVT gear ratio conversion is effectuated by the combination of pulleys 84, 88 (i.e., FIG. 2).

A second jackshaft 92 (FIG. 2) splined to pulley 88 enters the interior region 89 defined between frame plates 54 and 74. Jackshaft 92 extends through a roller bearing 95 that is mounted to vertically oriented frame plate 74 (i.e., FIG. 2) and terminates in a pillow block bearing 97 (FIG. 2) mounted to frame plate 54. Jackshaft 92 drives a pulley 104 operating a belt 108 entrained over a larger diameter, lower pulley 111 that is coupled to a gearbox drive shaft 113 adapted to be coupled to one of the trowel rotor drive inputs via flange 114. An opposite gearbox drive shaft 115 is adapted to be coupled to an the opposite rotor of the trowel. Gearbox and rotor details are discussed and illustrated in the previously cited references. Preferably an idler pulley 109 (i.e., FIG. 5) maintains proper belt tension. Gearbox drive shaft 113 is supported by spaced-apart bearings 116 (FIG. 2) and external 118 (FIG. 3).

In short, the Allen power transmission system takes the power of the engine, which is supplied at a particular rotating speed and torque, converts it to a higher speed and lower torque which is more suitable for the CVT apparatus 84, then converts back to a lower speed and higher torque which is necessary for the proper function of the machine.

Frame plates 54 and 74 are rigid and substantially flat and parallel. They are maintained in proper position by a plurality of rigid, elongated tubular sleeves 128. Each sleeve is compressively secured by a suitable bolt 131 (i.e., FIG. 4) that coaxially penetrates its respective sleeve and terminates in a locking nut

From the foregoing, it will be seen that this invention is one well adapted to obtain all the ends and objects herein set forth, together with other advantages which are inherent to the structure.

It will be understood that certain features and subcombinations are of utility and may be employed without reference to other features and subcombinations.

As many possible embodiments may be made of the invention without departing from the scope thereof, it is to be understood that all matter herein set forth or shown in the accompanying drawings is to be interpreted as illustrative and not in a limiting sense.

What is claimed is:

1. A modular, compartmentalized continuously variable ratio transmission adapted to be coupled between the drive motor of a dual rotor riding trowel and the lower trowel drive train that operates the trowel rotors, the transmission comprising:
a first rigid, generally planar frame plate;
a second rigid, generally planar frame plate spaced apart from said first frame plate in generally parallel relation therewith;
an interior region defined between said first and second frame plates forming a compartment for gear reduction components;
a plurality of spacers extending between said first and second frame plates;
a stub shaft for inputting power;
a first pulley splined to said stub shaft;
a second pulley having a diameter less than said first pulley diameter, said second pulley driven by said first pulley;
a first jackshaft driven by said second pulley;
a third pulley comprising a variable CVT driven by said first jackshaft;
a fourth pulley comprising a second CVT variable drive coupled to said third pulley;
a second jackshaft driven by said fourth pulley;
a fifth pulley driven by said second jackshaft;
a sixth pulley having a diameter greater than the diameter of said fifth pulley, and driven by said fifth pulley;
said sixth pulley driving trowel rotor drive inputs.

2. A modular, compartmentalized continuously variable ratio transmission adapted to be coupled between the drive motor of a dual rotor riding trowel and the lower trowel drive train that operates the trowel rotors, the transmission comprising:
a first rigid, generally planar frame plate comprising a clearance orifice for admitting a portion of the trowel internal combustion engine enabling the coupling of the module to the trowel engine;
a second rigid, generally planar frame plate spaced apart from said first frame plate in generally parallel relation therewith;
an interior region defined between said first and second frame plates forming a compartment for gear reduction components;
a plurality of spacers extending between said first and second frame plates for maintaining them in spaced relation;
a PTO stub shaft for inputting power;
a first pulley splined to said stub shaft;
a second pulley having a diameter less than said first pulley diameter, said second pulley spaced apart from said first pulley and coupled thereto by a drive belt;
said second pulley journalled for rotation between said first and second frame plates;
a first jackshaft driven by said second pulley;
a third pulley comprising a variable CVT drive affixed externally of the module driven by said first jackshaft;
a fourth pulley comprising a second CVT variable drive coupled to said third pulley by a belt;
a second jackshaft splined to said fourth pulley;
a fifth pulley driven by said second jackshaft;
a sixth pulley having a diameter greater than the diameter of said fifth pulley, and coupled thereto by a belt;
said sixth pulley driving a pair of gearbox drive shafts adapted to be coupled to trowel rotor drive inputs.
